(19) United States
(12) Patent Application Publication
(10) Pub. No.: US 2021/0031278 A1
(43) Pub. Date: Feb. 4, 2021

(54) DRILLING DEVICE COMPRISING A TUBULAR SHEATH SECURED TO AN ACTUATOR

(71) Applicant: RIO TINTO ALCAN INTERNATIONAL LIMITED, Montréal (CA)

(72) Inventors: Frédéric BRUN, Chicoutimi (CA); David MUNOZ, Meylan (FR); Steeve RENAUDIER, Saint Michel de Maurienne (FR)

(21) Appl. No.: 16/963,997

(22) PCT Filed: Jan. 23, 2019
(86) PCT No.: PCT/CA2019/050081

§ 371 Date: Jul. 22, 2020

(30) Foreign Application Priority Data
Jan. 24, 2018 (FR) 18/70066

(51) Int. Cl. B23B 51/04; C25C 3/14; C25C 1/02

(52) U.S. Cl. CPC B23B 51/0406; C25C 1/02; C25C 3/14

(57) ABSTRACT

Drilling device comprising an actuator comprising an actuator body and a rod bearing at its free end a drill bit, a tubular sheath secured to the actuator body and comprising walls surrounding the drill bit and a lower opening, a system for detecting contact between the drill bit and the electrolyte bath by analysis of an electric signal; the tubular sheath being secured to the actuator body by means of an electrically insulating fastener, and the rod and the drill bit being remote from the walls of the tubular sheath when the drill bit is moved with respect to at least one lower portion of the tubular sheath and below the lower opening.

### TECHNICAL FIELD

The present invention relates to the general technical field of the production of aluminum by electrolysis in an electrolytic cell containing an electrolyte bath based on cryolite, and more specifically a piercing device of the alumina feed device for this electrolytic cell.

The piercing device can be mounted on an electrolytic cell with pre-baked anodes or on a continuous anode electrolytic cell known as a Söderberg cell.

### PREPARATION OF PRIOR ART

Aluminum is mostly produced by electrolysis of alumina dissolved in an electrolyte bath. Currently, the production of aluminum on an industrial scale is carried out in an electrolytic cell composed of a steel pot shell open in its upper part, and whose inside is covered with refractory material, and a cathode surmounted by one or more anodes, the anode being immersed in the electrolyte bath at a temperature ranging between 930 and 980° C.

An electric current is applied between the anode and the cathode to initiate the electrolysis reaction. The anode is gradually consumed during the electrolysis reaction. Once the anode is spent, it is replaced by a new anode.

In the production of aluminum by electrolysis, a solidified crust of alumina and solidified electrolyte forms on the surface of the electrolyte bath. The formation of this crust thermally isolates the electrolyte bath and confines some of the polluting gases generated by the electrolysis reaction.

However, the production of aluminum by electrolysis leads to a permanent change in the composition of the electrolyte bath, in particular in the alumina content of the electrolyte bath, since the alumina is consumed by the electrolysis reaction to form aluminum. The electrolysis reaction also produces gas at the interface between the anode and the cathode, for example carbon dioxide.

It is therefore necessary to add alumina to the electrolyte bath on a regular basis in order to stabilize and to regulate the operating parameters of the electrolytic cell.

This is why an electrolytic cell is usually equipped with alumina feed devices consisting of piercing devices for making holes in the crust by piercing, and metering devices for adding alumina in powder form through said holes.

Each piercing device usually comprises a jack provided with a piercing component (known by the names of “plunger” or “chisel”) attached to the end of a rod of the jack. The piercing component is lowered by activating the jack to break the crust extending over the electrolyte bath.

Each metering device typically comprises a metering unit to regulate the flow of alumina to be introduced into the electrolyte bath from a hopper and a feed through to direct the gravity flow of alumina from the metering unit to the hole formed in the crust by the piercing device.

To prevent any short-circuiting of the electrolysis current that has to pass through the anodes via the piercing device, when the piercing component comes into contact with the electrolyte bath, the piercing device, and generally the alumina feed device as a whole is typically attached to the superstructure which supports it with electrically insulating fastening means. The superstructure supporting the piercing device is at the electric potential of the anode frame, while the electrolyte bath is at the electric potential of the lower part of the anodes. The piercing device thus moves with floating or variable electric potential.

Also, in order to prevent the piercing component from plunging deeply into the electrolyte bath and rapidly deteriorating, it is known, particularly from publication FR2483965, how to detect with each downward movement of the piercing component the time at which the piercing component comes into contact with the electrolyte bath and to order the piercing component to rise when this contact is detected. Contact between the piercing component and the electrolyte bath is detected by measuring the variation in electrical potential between the piercing component and a point on the electrolytic cell taken as a reference potential. Such detection of the contact between the piercing component and the electrolyte bath, based on a variation of an electrical signal is particularly quick, simple and reliable.

Alumina feeders are typically arranged at regular intervals along a central corridor between two rows of anodes. The anodes are coated with a powdery, typically cryolite and alumina based coating material to minimize heat loss from the electrolyte bath into the cell. This also minimizes the combustion of carbon-based anodes above the electrolyte bath. The powdery covering material periodically collapses into the holes formed by the piercing devices and impairs the efficiency of the covering. In addition, these collapses cause agglomerations to form on the surface of the cathode, which reduces its overall conductivity. This uncontrolled addition of powder also alters the composition of the electrolyte bath and disrupts the alumina feeder control system, resulting in a deterioration of the reaction efficiency of the electrolytic cell. These collapses can sometimes still cause the alumina feed hole to become blocked and may cause the alumina feeder to fail.

The holes drilled in the crust by the piercing devices form outlets for gases generated during the electrolysis reaction and trapped under the crust. Also, the exhaust flow of these gases is great around the holes in the crust and causes some of the alumina flowing by gravity from the feed channels to the holes to fly off. The alumina used for the production of aluminum is in fact in the form of very fine, light, easily volatile particles. Some of the alumina coming out of the metering unit does not therefore reach the electrolyte bath but disperses inside the electrolytic cell, typically on the anode covering material. These uncontrolled fly-offs also disrupt the alumina feed control system, resulting in a deterioration of the reaction efficiency of the electrolytic cell.

In order to improve control of the cells, alumina feeder control systems favor a quasi-continuous supply of alumina, i.e. by means of a trickle of alumina flowing almost continuously, rather than periodically introduced masses of alumina. A quasi-continuous alumina feeder is notably disclosed in publication WO93/14248. The problem of fly-offs is therefore amplified because a trickle of alumina or isolated grains of alumina are more subject to fly-offs than a mass of alumina.

Publications CN102628170 and CN202323057 disclose an alumina feed device comprising a metal sheath embedded in the powdery covering material through which a thrust mechanism moves, pushing the alumina accumulating in the lower part of the sheath into the electrolyte bath. The sheath prevents the covering material from collapsing into the hole formed in the crust and would also, according to the applicant, make it possible to keep the hole formed in the crust open without the need for any piercing. The use of such a sheath is, however, incompatible with reliable detection of the contact between the thrust mechanism and the electrolyte bath, based on a variation of an electrical signal. The sheath is at the electrical potential of the covering material so that the thrust mechanism guided within it and the associated jack moving the thrust mechanism are also at the electric potential of the covering material. The electric potential of the covering material, which may touch the electrolyte bath, changes within a range which is very close to the electric potential of the electrolyte bath so that an electric potential variation of the thrust mechanism cannot reliably be detected when the thrust mechanism comes into contact with the electrolyte bath.

Publication CN102260882 also discloses an alumina feed device comprising a sheath. This sheath, attached to the lower end of the jack is formed of composite material. Such a sheath is bulky and therefore difficult to position between the anodes. Also, it is expensive to design and its service life is very limited because of its exposure to impacts, high temperatures and cell gases.

One aim of the present invention is to propose a piercing device to ensure reliable control of the amount of alumina introduced into the electrolyte bath, which is simple in design and with limited maintenance requirements.

### SUMMARY OF THE INVENTION

To this end, the invention proposes a piercing device for piercing an opening in an alumina and solidified electrolyte crust forming above an electrolyte bath;
a jack comprising a jack body and a rod carrying a piercing component at its free end, the jack allowing linear movement of the piercing component between a high position and a low position;
a tubular sheath attached to the jack body and having walls surrounding the piercing component and a lower opening;

characterized in that the piercing device comprises a system for detecting a contact between the piercing component and the electrolyte bath by analyzing an electrical signal associated with a system controlling movement of the piercing component to control movement of the piercing component towards the high position when said contact is detected, in that the tubular sheath is attached to the jack body by means of an electrically insulating fastener and in that the rod and the piercing component are distant from the walls of the tubular sheath when the piercing component is moved opposite at least one lower portion of the tubular sheath and below the lower opening.

Such a sturdy, inexpensive configuration makes it possible to ensure that the electrical potential of the piercing component and the jack remains independent of the electrical potential in which the tubular sheath is located, in particular when the piercing component moves within the zone in which it is likely to come into contact with the alumina and solidified electrolyte crust or with the electrolyte bath, i.e. when it moves in relation to at least one lower portion of the tubular sheath and below the lower opening.

Problems of disrupted detection of the contact between the piercing component and the electrolyte bath by analysis of an electrical signal when the piercing device comprises a tubular sheath introduced partly into the powdery covering material placed above the electrolyte bath are therefore resolved. This helps to limit deterioration of the piercing device, in particular of the piercing component, and therefore maintenance of the piercing device, and to ensure a reliable, controlled supply of alumina to the electrolytic cell.

Advantageously, the piercing device comprises electrically insulating fastening means to give electrically insulating fastening of the piercing device to an element of the electrolytic cell.

Such an embodiment makes it possible to keep the piercing component and the jack at a floating electric potential or at a controlled electrical potential when the piercing component is not in contact with the alumina and solidified electrolyte crust or with the electrolyte bath.

According to one embodiment, the piercing device comprises an electrical connection between the detection system and the piercing component. Advantageously, this electrical connection is made via an electrical connection on the rod or body of the jack. Electrical conduction is provided between the rod or body of the jack and the piercing component to allow variation in electrical potential of the piercing component to be detected. This electrical conduction or electrical connection can be achieved by means of a sliding electrical contact.

Advantageously, the rod and the piercing component are distant from the walls of the tubular sheath regardless of the position of the piercing component. In this way, electrical insulation is provided between the jack and the tubular sheath, regardless of the position of the piercing component. The electric potential of the jack is then at all times independent of the electric potential of the tubular sheath.

According to a particular embodiment, the tubular sheath comprises a scraper arranged to rub against the surface of the piercing component when the piercing component moves towards the high position and in which the lower portion of the tubular sheath extends between the lower end of the scraper and the lower opening of the tubular sheath. The scraper makes it possible to detach any agglomerated electrolyte bath adhering to the surface of the piercing component. The scraper is typically positioned near the top position of the piercing component. The piercing component may therefore be in electrical contact with the scraper, and therefore with the tubular sheath when it is in the high position or close to the high position. However, when the piercing component is moving below the lower end of the scraper, it is no longer in electrical contact with the scraper.

Advantageously, the piercing component comprises means for deactivating the detection system when the piercing component is opposite the scraper. In this way, when the piercing component is opposite the scraper, and therefore potentially at the electrical potential of the tubular sheath, the detection system cannot control movement of the piercing component to the upper position.

Advantageously, the jack body, the rod, the piercing component and the tubular sheath are made of metal, preferably based on steel. Making these components from steel makes it possible to limit the manufacturing costs of the piercing device. Also, steel endows the piercing device with good durability in the very difficult environment inside the electrolytic cell.

The electrical conductivity of the metal forming these components induces the electrical stresses causing the problem solved by the present invention but also contributes to detection of the contact between the piercing component and the electrolyte bath by the detection system.

According to one embodiment, the tubular sheath comprises at least two parts and the tubular sheath is fixed to the jack body by assembling these parts to each other around the jack body with a sleeve made of electrically insulating material interposed between the tubular sheath and the jack body. The sleeve made of electrically insulating material is compressed between the tubular sheath and the jack body and is thus protected from the corrosive environment within the electrolytic cell. This way of fixing the tubular sheath onto the jack by strapping with a sleeve of interposed electrically insulating material is also particularly suitable for making the piercing device according to the invention from piercing devices of prior art not comprising a tubular sheath but only a cylinder.

According to one variant, the tubular sheath is attached to the jack body by means of electrically insulating bolting. For this purpose, the jack body and the tubular sheath may for example comprise complementary collars with openings to make the electrically insulating bolting.

According to a preferred embodiment of the invention, the jack body comprises rod guiding means extending at least partly below the electrically insulating fastener between the jack body and the tubular sheath. The cylinder of the jack is typically arranged above the ceiling of the tank so that operation of the jack is not disturbed by the high temperatures inside the electrolytic cell. The rod of the jack is therefore of considerable length so that the piercing component can come into contact with the electrolyte bath. In order to ensure proper guiding of the rod, the guide means extend into the electrolytic cell under the ceiling of the superstructure, typically as close as possible to the covering material. In the lower part of the guiding means, exposure to corrosive gases is very great and the temperature is very high. The electrically insulating fastener is therefore advantageously made as close as possible to the ceiling of the superstructure to prevent it from deteriorating rapidly and requiring frequent replacement. The electrically insulating fastener is advantageously made at an upper end of the tubular sheath so that an upper portion of the tubular sheath extends around the jack body and more particularly the guiding means. Such a configuration, which seems neither logical nor optimal in terms of raw materials needed, significantly reduces maintenance requirements.

The invention also relates to an electrolytic cell comprising anodes supported by a superstructure and partly immersed in an electrolyte bath, covering material covering the anodes and the electrolyte bath, characterized in that the electrolytic cell comprises a piercing device as described above, in that the lower portion of the tubular sheath is introduced wholly or partly into the covering material, and in that the jack is fixed to the superstructure by means of an electrically insulating fastener.

According to a preferred embodiment, the piercing device is associated with an alumina metering device capable of pouring alumina into a supply duct opening into the tubular sheath.

### BRIEF DESCRIPTION OF THE FIGURES

Other advantages and characteristics of the piercing device and the electrolytic cell will become apparent from the following description of embodiments, given by way of non-limiting examples, from the attached drawings, in which:

FIG. 1 is a schematic cross-section view of an electrolytic cell with an alumina feeder device comprising a piercing device according to the invention,

FIG. 2 is a partial schematic sectional view of a second particular embodiment of a piercing device according to the invention,

FIG. 3 is a sectional view along A-A of the piercing device of FIG. 2,

FIGS. 4a and 4b are partial schematic views of a third particular embodiment of a piercing device according to the invention, when the piercing component is in the high position and when the piercing component is moving, especially moving downwards, respectively.

### DETAILED DESCRIPTION

We will now describe an example of an electrolytic cell including one or more alumina feeders comprising a piercing device according to the invention to form a hole in an alumina and solidified electrolyte crust through which the alumina is introduced into the electrolyte bath.

In the figures, equivalent elements bear the same reference numerals.

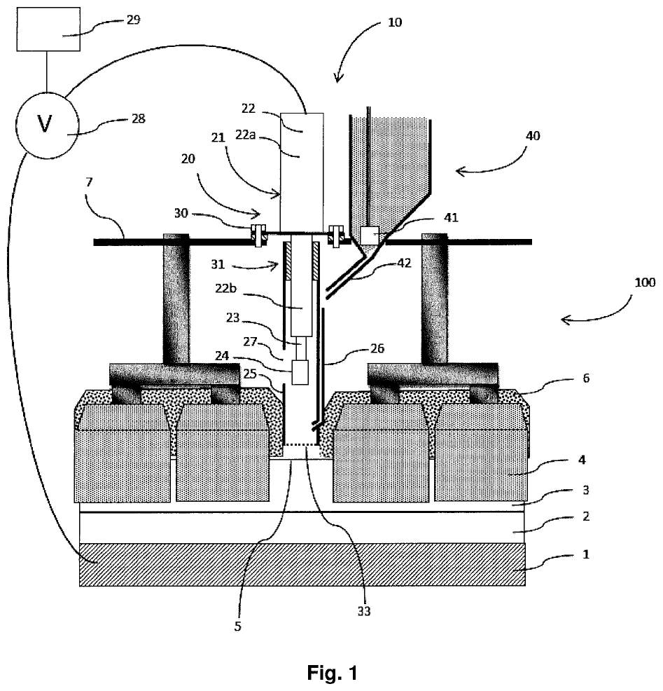

FIG. 1 illustrates an example of an electrolytic cell according to the invention.

The electrolytic cell 100 consists of a cathode 1 on which an aluminum layer 2 is deposited as the electrolysis reaction progresses. The layer of aluminum 2 is covered by an electrolyte bath 3 in which anodes 4 are immersed. A crust 5 of alumina and solidified electrolyte is formed on the surface of the electrolyte bath 3 and covering material 6 is deposited on anodes 4 and crust 5.

The electrolytic cell 100 is equipped with an alumina feeder device 10, comprising a piercing device 20 and a metering device 40. Piercing device 20 and metering device 40 are partly arranged inside electrolytic cell 100, under the cell ceiling 7.

Piercing device 20 comprises a jack 21, comprising a jack body 22 and a rod 23, at the end of which a piercing component 24 extends. Piercing component 24 is lowered periodically by activating jack 21 to break crust 5. The jack body 22 is more particularly made up of a jack cylinder 22a, typically arranged above the cell ceiling 7, and guiding means 22b which extend into the electrolytic cell 100 under the tank ceiling 7 and provide proper guiding of jack rod 23.

Piercing device 20 also includes a tubular sheath 25 extending vertically around the piercing component 24 along its movement. The tubular sheath 25 is partially embedded in the covering material 6. The piercing component 24 exits the tubular sheath 25 through a lower opening 33 to strike and pierce the crust 5.

The tubular sheath 25 prevents the coating material 6 from collapsing into the hole in the crust 5 formed by the piercing component 24. The tubular sheath 25 may comprise, as shown in FIG. 1, a duct 26 for supplying alumina opening into the tubular sheath 25 and an opening 27 for discharging gases resulting from the electrolysis process.

The metering device 40 comprises a metering unit 41 and a trough 42 capable of discharging alumina into the feed duct 26 by gravitational flow. The trough 42 is advantageously placed at a distance from the feed duct 26. Maintenance operations on the metering device 40 can in this way be performed without any need to work on the piercing device 20, and vice versa. Also, the electrical potentials of the metering device 40 and the piercing device are dissociated.

The piercing device 20 further comprises a system 28 for detecting contact between the piercing component and the electrolyte bath and a system 29 for controlling movement of the piercing component 24.

The detection system 28 measures an electrical signal, and more particularly the electric potential difference, between a reference point on the electrolytic cell, in FIG. 1 a point on the cathode, and a point on the jack 21 electrically connected to the piercing component, and analyzes the electrical signal measured to determine whether the piercing component 24 has come into contact with the electrolyte bath 3. The detection system 28 transmits information to the system 29 controlling movement of the piercing component 24 to control movement of the piercing component towards the high position when contact between the piercing component 24 and the electrolyte bath 3 is detected.

The detection system 28 is electrically connected to the piercing component 24 to determine a variation in the electric potential of the piercing component 24 when the latter, after having pierced the crust 5, comes into contact with the electrolyte bath 3 and acquires the same electrical potential as the electrolyte bath 3. The electrical connection between the detection system 28 and the piercing component 24 is made via the jack rod 23 and body 22 in the embodiment shown in FIG. 1. Electrical conduction within the jack 21 advantageously results from the component parts, and more particularly the piercing component 24, the rod 23 and the jack body 22 being manufactured from conductive metal, and more particularly from steel. A sliding electrical contact may also be used to give a reliable electrical connection between the moving rod 23 and a fixed element, for example belonging to the jack body 22.

Advantageously, the jack body 22, the rod 23, the piercing component 24 and the tubular sheath 25 are made of metal, preferably based on steel, and therefore also conductive. Making these components from steel makes it possible to limit the manufacturing costs of the piercing device and the space it takes up in the electrolytic cell. Also, steel endows the piercing device with good durability in the very difficult environment inside the electrolytic cell. The electrical conductivity of the metal forming these components induces the electrical stresses causing the problem solved by the present invention but also contributes to detection of the contact between the piercing component and the electrolyte bath by the detection system 28.

The piercing device 20 comprises electrically insulating fastening 30 means to give electrically insulating fastening of the piercing device to an element of the electrolytic cell. The electrically insulating fastening means 30 may be electrically insulating bolting of conventional type with a washer made of electrically insulating material interposed between the elements to be fastened. The piercing device 20 is more particularly fixed with the electrically insulating fastening means 30 onto the ceiling 7 of the electrolytic cell 100 from a collar formed on the jack body 22. The electrically insulating fixing means 30 make it possible to avoid any short-circuiting of the electrolysis current through the jack 20 between the cell ceiling 7 and the electrolyte bath 3 when the piercing component 24 comes into contact with the electrolyte bath 3. The electrically insulating fastening means 30 further make it possible to keep the piercing component and the jack at a floating electric potential or at a controlled electrical potential when the piercing component is not in contact with the alumina and solidified electrolyte crust 5 or with the electrolyte bath 3.

The tubular sheath 25 is, according to the invention, fixed to the jack body 22, and more particularly to the guiding means 22b, by means of an electrically insulating fastener 31. In this way, the jack body 22 is electrically insulated from the tubular sheath 25.

In the embodiment shown in FIG. 1, the electrically insulating fastener 31 is made as close as possible to the ceiling 7 of the cell, where the temperature and exposure to corrosive gases are the lowest. In this way, the jack body 22 comprises guiding means 22b for the rod 23 extending at least partly below the electrically insulating fastener 31 between the jack body and the tubular sheath. The electrically insulating fastener 31 is formed at the upper end of the tubular sheath 25 so that an intermediate portion of the tubular sheath 25 extends under the electrically insulating fastener 31 around the jack body 22 and more particularly the guiding means 22b.

Also, in the embodiment shown in FIG. 1, the rod 23 and the piercing component 24 are at a distance from the walls of the tubular sheath 25, regardless of the position of the piercing component 24 during its vertical translation movement between a high rest position and the position of contact with the electrolyte bath 3 after having pierced the crust 5.

Consequently, the electric potential of the piercing component 24 seen by the detection system 28 is totally independent of the electrical potential of the tubular sheath 25.

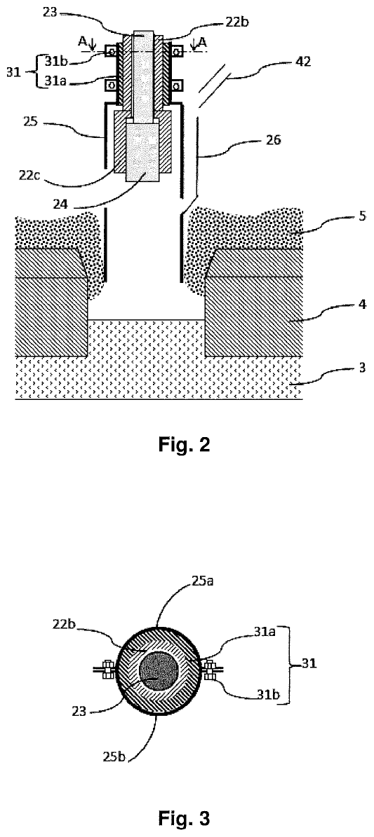

The second embodiment according to the invention shown in FIGS. 2 and 3 differs mainly from the embodiment shown in FIG. 1 in that the jack body 22 comprises a scraper 22c arranged as an extension of the guiding means 22b under the guiding means 22b and in that the electrically insulating fastener 31 between the tubular sheath 25 and the jack body 22 is formed at the lower end of the guiding means 22b.

The tubular sheath 25 is formed of two parts 25a and 25b assembled together. The electrically insulating fastener 31 is made by means of a sleeve 31a made of an electrically insulating material threaded around the guiding means 22b and bolts 31b making it possible to assemble and grip the two parts 25a, 25b of the tubular sheath 25 around the sleeve 31a and guiding means 22b.

The scraper 22c is formed of claws which rub against the surface of the piercing component 24 when the piercing component 24 moves towards the top position (shown in FIGS. 2 and 3) in order to knock down any electrolyte bath residues agglomerated on the surface of the piercing component 24. The scraper 22c is part of the jack body 22 and is, like the other components of the jack body 22, made of metal and more particularly steel. The scraper 22c may be in electrical contact with the other constituent parts of the jack body 22, such as the guiding means 22b or the jack cylinder 22a, and with the piercing component 24 and the rod 23. It is, however, at a distance from the walls of the tubular sheath 25 and therefore with no electrical contact with the latter.

In the second embodiment, as in that shown in FIG. 1, the rod 23 and the piercing component 24 are at a distance from the walls of the tubular sheath 25, regardless of the position of the piercing component 24 during its vertical translation movement between a high rest position and the position of contact with the electrolyte bath 3 after having pierced the crust 5.

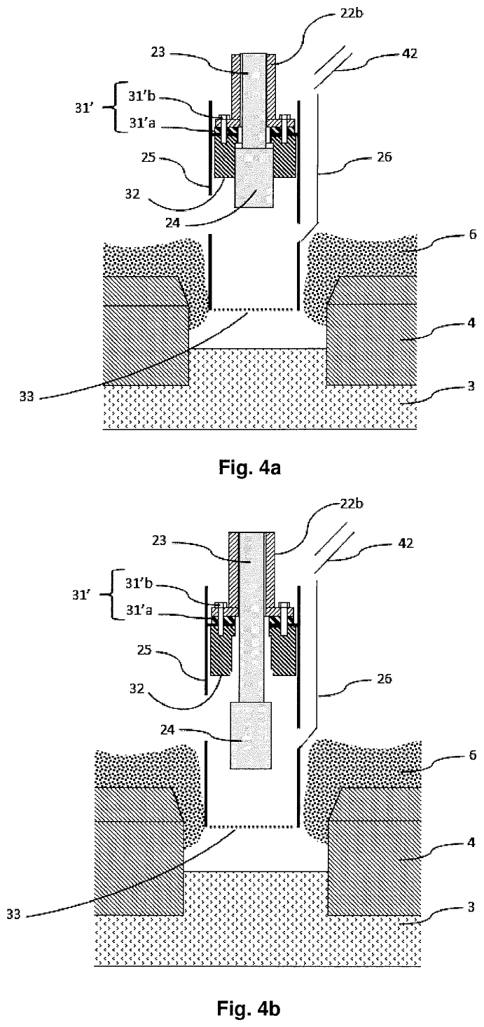

The third embodiment according to the invention shown in FIGS. 4a and 4b differs mainly from the second embodiment in that the scraper 32 is a component of the tubular sheath 25 and not the jack body 22, and in that the electrically insulating fastener 31′ is different.

The electrically insulating fastener 31′ is made by means of electrically insulating bolting. The electrically insulating bolting may in particular be made by means of washers 31′a made of an electrically insulating material inserted between a collar made at the lower end of guiding means 22b and a complementary collar formed on the tubular sheath 25 and electrically insulating bolts 31′b making it possible to assemble the collars by enclosing the washers 31′a.

The scraper 32 is a constituent part of the tubular sheath 25 and is advantageously made of metal and more particularly of steel. It is therefore at the electric potential of the covering material 6 in which the tubular sheath 25 is partially embedded. The piercing component 24 rubs against the scraper 32 and touches it when the piercing component 24 is opposite the scraper 32, and in particular when the piercing component 24 is in the top position (as shown in FIG. 4a). Consequently, the piercing component 24 is at the electric potential of the covering material 6 when the piercing component 24 is opposite the scraper 32. The piercing component 24 regains a floating electric potential when the piercing component 24 is no longer opposite the scraper 32 (as shown in FIG. 4b), since the piercing component 24 and the rod 23, with a section typically lower than that of the piercing component 24, are then distant from the walls of the tubular sheath 25, and in particular from the scraper 32. The scraper 32 belongs to an upper portion of the tubular sheath 25. Also, the rod 23 and the piercing component 24 are distant from the walls of the tubular sheath 25 when the piercing component 24 is moved opposite at least one lower portion of the tubular sheath and below the lower opening 33 of the tubular sheath. The lower portion of the tubular sheath 25 extends according to the third embodiment shown in FIGS. 4a and 4b between the lower end of the scraper 32 and the lower opening 33 of the tubular sheath 25.

To avoid a detection error by the system 28 detecting contact between the piercing component 24 and the electrolyte bath 3, the detection system 28 can be disabled when the piercing component 24 is opposite the scraper 32 and therefore possibly at the electric potential of the tubular sheath 25. This disabling is equivalent, for example, to the period of movement of the piercing component 24 over a determined portion of the travel of the piercing component 24 of the jack 21 from the high position.

The alumina feeder piercing device described above has numerous advantages, in particular with reference to the operation of an electrolytic cell used for producing aluminum. The piercing device 20 according to the invention can advantageously be produced simply and effectively by modifying a piercing device used on a large number of electrolytic cells currently in operation, comprising a jack 21 of the type shown in the figures, together with a system 28 for detecting contact between the piercing component 24 and the electrolyte bath 3 but not comprising a tubular sheath 25.

1. A piercing device for piercing an opening in a solidified alumina and electrolyte crust forming above an electrolyte bath contained in an electrolytic cell comprising:
a jack comprising a jack body and a rod carrying a piercing component at a free end thereof, the jack allowing linear movement of the piercing component between a high position and a low position;
a tubular sheath attached to the jack body and having walls surrounding the piercing component and a lower opening; and
a system for detecting a contact between the piercing component and the electrolyte bath by analyzing an electrical signal associated with a system controlling movement of the piercing component to control movement of the piercing component towards the high position when said contact is detected, wherein the tubular sheath is attached to the jack body by means of an electrically insulating fastener, and wherein the rod and the piercing component are distant from the walls of the tubular sheath when the piercing component is moved opposite at least one lower portion of the tubular sheath and below the lower opening.

2. Piercing device according to claim 1, further comprising electrically insulating fastening means to provide electrically insulating fastening of the piercing device to an element of the electrolytic cell.

3. Piercing device according to claim 1, further comprising an electrical connection between the detection system and the piercing component.

4. Piercing device according to claim 3, in which the electrical connection between the detection system and the piercing component is effected by means of an electrical connection on the jack rod or body.

5. Piercing device according to claim 1, in which the rod and the piercing component are distant from the walls of the tubular sheath regardless of the position of the piercing component.

6. Piercing device according to claim 1, in which the tubular sheath comprises a scraper arranged to rub against the surface of the piercing component when the piercing component moves towards the high position and in which the lower portion of the tubular sheath extends between the lower end of the scraper and the lower opening of the tubular sheath.

7. Piercing device according to claim 6, comprising means for disabling the detection system when the piercing component is opposite the scraper.

8. Piercing device according to claim 1, in which the jack body, the rod, the piercing component and the tubular sheath are made of metal.

9. Piercing device according to claim 1, in which the tubular sheath comprises at least two parts and in which the tubular sheath is fixed to the jack body by assembling these parts to each other around the jack body with a sleeve made of electrically insulating material interposed between the tubular sheath and the jack body.

10. Piercing device according to claim 1, in which the tubular sheath is attached to the jack body by means of electrically insulating bolting.

11. Piercing device according to claim 1, in which the jack body comprises guiding means for the rod extending at least partly below the electrically insulating fastener between the jack body and the tubular sheath.

12. An electrolytic cell comprising anodes supported by a superstructure and partly immersed in an electrolyte bath, covering material covering the anodes and the electrolyte bath, wherein the electrolytic cell comprises a piercing device according to claim 1, and wherein the lower portion of the tubular sheath is introduced wholly or partly into the covering material, and in that the jack is fixed to the superstructure by means of an electrically insulating fastener.

13. Electrolytic cell according to claim 12, in which the piercing device is associated with an alumina metering device configured for discharging alumina into a feed duct opening into the tubular sheath.
